(19) United States
(12) Patent Application Publication
(10) Pub. No.: US 2002/0129560 A1
(43) Pub. Date: Sep. 19, 2002

(54) Acidic polishing slurry for the chemical-mechanical polishing of SiO2 isolation layers

(76) Inventors: Kristina Vogt, Koln (DE); Lothar Puppe, Burscheid (DE); Chun-Kuo Min, Taipei (TW); Li-Mei Chen, Hsinchu (TW)

Correspondence Address: BAYER CORPORATION, PATENT DEPARTMENT, 100 BAYER ROAD, PITTSBURGH, PA, 15205, US

(21) Appl. No.: 10/023,174

(22) Filed: Dec. 17, 2001

(30) Foreign Application Priority Data
Dec. 20, 2000 (DE) 10063491.5

(51) Int. Cl. C09C 1/68; C09K 3/14

(52) U.S. Cl. 51/308; 106/3

(57) ABSTRACT

An acidic polishing slurry for chemical-mechanical polishing, containing 0.1 to 5% by weight of a colloidal silica abrasive and 0.5 to 10% by weight of a fluoride salt, is distinguished by a higher polishing selectivity with regard to the rate at which silica is removed compared to the rate at which silicon nitride is removed compared to a conventional polishing slurry containing pyrogenic silica.

### BACKGROUND

The present invention relates to an acidic polishing slurry for the chemical-mechanical polishing of SiO₂ isolation layers which have been produced using the STI (shallow trench isolation) technique, and in particular to a colloidal polishing slurry of the silica type which contains a fluoride salt.

Nowadays, chemical-mechanical polishing (CMP) is a preferred method in the fabrication of integrated circuits (ICs) in order to achieve global planarization on wafers. A wafer is a polished disc of silicon on which integrated circuits are constructed. First of all, a polishing slurry is applied to an elastomeric polishing pad or directly to the wafer surface which is to be polished. The polishing pad is then pressed against the surface which is to be polished and, in the process, is moved relative to the wafer plane, so that the particles of the polishing slurry are pressed onto the wafer surface. The movement of the polishing pad causes the polishing slurry to be distributed and therefore causes the particles on the wafer surface to be distributed, leading to chemical and mechanical removal of the substrate surface.

Polishing slurries can be divided into two categories. One category comprises a suspension of pyrogenic silica as abrasive, and the other category contains colloidal silica as abrasive. The methods for preparing the polishing slurries from pyrogenic silica and from colloidal silica, also known as silica sol, are different. The suspension of pyrogenic silica is obtained by dispersing pyrogenic silica in an aqueous medium. For polishing slurries which contain colloidal silica, the colloidal silica is produced directly, by means of the sol-gel technique, from an aqueous solution, e.g. from a sodium silicate solution. At no time during production is the colloidal silica in a dry state which may lead to agglomeration or aggregation, as is the case with the pyrogenic silica. The suspension of pyrogenic silica has a wider particle size distribution than the polishing slurry from the colloidal silica category. This leads to the particles of the polishing slurry comprising pyrogenic silica agglomerating or forming a sediment during storage and/or polishing, which additionally leads to a non-uniform particle size distribution. Therefore, when using the polishing slurry comprising pyrogenic silica, defects such as surface roughness and microscratches are produced on the polished semiconductor surface. The seriousness of this phenomenon increases if the line width of the IC component falls to 0.25 μm or 0.18 μm or below. Therefore, the polishing slurry belonging to the colloidal silica category is becoming increasingly widespread.

In integrated semiconductor technology, it is usually necessary for a plurality of active and passive elements within the integrated circuit structure to be isolated from one another. This is often achieved using the STI technique, which is able to resolve the problems of field oxide diffusion which occurs in the LOCOS process and of mechanical stresses and has the advantage of resulting in a good isolating action and of increasing the integration density and planarization of the IC component. Therefore, STI has become the principal isolation technique used for the 0.18 μm CMOS technology.

The STI technique comprises the generation of a narrow trench in the silicon, filling the narrow trench with silica (SiO₂), with the entire wafer surface at the same time being covered with a film of silica, followed by planarization using the CMP technique. It is customary for a harder silicon nitride (Si₃N₄) film previously to have been formed beneath the silica film which is to be polished, so that the silicon nitride film acts as a stop layer during the polishing. An ideal polishing slurry which is eminently suitable for use is, on the one hand, able to effectively polish the silica film above the narrow trench without, on the other hand, polishing off the silicon nitride film. This means that it is desirable to use a polishing slurry in which the rate of polishing of the silica film is as high as possible and the rate of polishing of the silicon nitride film is virtually zero.

An index which is customarily used to assess the rate of polishing of silica on silicon nitride is the polishing selectivity, which is defined by dividing the polishing rate of silica by the polishing rate of silicon nitride. If a polishing slurry with a low SiO₂/Si₃N₄ selectivity is used to polish the SiO₂ which is situated above the trench, what is known as dishing of the SiO₂ and erosion of the Si₃N₄ occur.

In current IC fabrication, the selectivity of the CMP polishing slurries used is not sufficiently high. Therefore, one shortens the duration of polishing and, to avoid the problem known as dishing of the SiO_{2,} uses the reactive ion etching (RIE) technique. However, this combined RIE+CMP process lengthens the overall production time by approximately 40% and therefore increases production costs.

A method which is normally used to increase the polishing selectivity of a polishing slurry comprising pyrogenic silica consists in adding sodium hydroxide or potassium hydroxide in a high concentration, in order to increase the pH at 22° C. to over 12.5. Then, however, pitting occurs on the polished semiconductor surface.

Various polishing slurries have been developed for increasing the polishing selectivity with regard to the rate at which silica is removed compared to the rate at which silicon nitride is removed. U.S. Pat. No. 4,526,631 describes a polishing slurry comprising 6% by weight of colloidal silica, which is set to a pH at 22° C. of approximately 12 using KOH, with a polishing ratio of approximately 10 SiO₂ to 1 Si₃N₄. In U.S. Pat. No. 5,738,800, the polishing composition for polishing a combination of silica and silicon nitride contains an aromatic compound which forms complexes with silica and silicon nitride. In U.S. Pat. No. 5,759,917, the composition comprises ammonium cerium nitrate, acetic acid and pyrogenic silica. In U.S. Pat. No. 5,733,819, the polishing composition comprises fine silicon nitride powder, water and an acid. In EP-A-853 335, the composition comprises pyrogenic silica as abrasive, a tetramethylammonium salt and hydrogen peroxide. EP-A 853 110 provides an alkalized polishing slurry for improving the polishing selectivity, this slurry containing a fluoride salt.

Therefore, the object of the present invention is to solve the above problems and to provide an acidic, colloidal polishing slurry of the silica type for chemical-mechanical polishing with a high polishing selectivity in terms of the rate at which silica is removed compared to the rate at which silicon nitride is removed.

To achieve the above object, the acidic polishing slurry of the present invention contains the following components:

0.1 to 5% by weight of a colloidal silica abrasive, and 0.5 to 10% by weight of a fluoride salt.

### SUMMARY

As such, the invention relates to an acidic polishing slurry comprising (a) from about 0.1 to about 5%, by weight, of a colloidal silica abrasive, and (b) from about 0.5 to about 10%, by weight, of a fluoride salt. In one embodiment, the invention relates to a method comprising polishing a composite material containing silica and silicon nitride with an acidic polishing slurry comprising (a) from about 0.1 to about 5%, by weight, of a colloidal silica abrasive, and (b) from about 0.5 to about 10%, by weight, of a fluoride salt. These and other features, aspects, and advantages of the present invention will become better understood with reference to the following description and appended claims.

### DESCRIPTION

The acidic polishing slurry of the present invention is particularly suitable for the chemical-mechanical polishing of SiO₂ isolation layers produced using the STI technique. The polishing slurry is preferably used to polish a combination which contains silica and silicon nitride. The polishing slurry is particularly preferably used to polish a dielectric film, such as for example a silica film, which is formed on a silicon nitride film, the silicon nitride film being used as a stop layer.

In the polishing slurry of the present invention, the colloidal silica abrasive is preferably present in a quantity of from about 0.1 to about 3.5% by weight, and the fluoride salt is present in a quantity of from about 1 to about 6% by weight. The colloidal silica may have a mean particle size of 10 nm to 1 μm, preferably 20 nm to 100 nm.

The mean particle size is determined in an untracentrifuge.

The fluoride salt which is used in the present invention may be an ammonium salt. Ammonium fluoride and ammonium hydrogen fluoride are particularly suitable. The fluoride salt may form a strong bond with silica and may convert the silicon nitride surface to a hydrophobic state, so that the hydrolysis of silicon nitride is inhibited. In this way, the polishing selectivity with regard to the rate at which silica is removed compared to the rate at which silicon nitride is removed is increased.

The polishing slurry of the present invention may furthermore contain an inorganic acid which is used to adjust the pH of the polishing slurry. The pH at 22° C. of the polishing slurry of the present invention is preferably 2 to 6.

The selectivity of the polishing slurry of the present invention can be increased to up to 12; therefore, there is no need for an additional technique, such as RIE, in order to effect the planarization. Therefore, the overall production time can be reduced and production costs can be saved.

The polishing slurry of the present invention is acidic. Therefore, the problems which occur with the basic polishing slurry, such as for example pitting, on the polished semiconductor surface can be avoided.

The examples which follow are intended to explain the process and the advantages of the present invention more extensively, without restricting the scope thereof, since numerous modifications and variations are evident to the person skilled in the art. All parts and percentages are by weight unless otherwise indicated.

### EXAMPLES

The polishing slurries of the examples and comparative examples were produced in accordance with the instructions given below. The polishing slurries were used to polish films on silicon wafers by means of a Westech-372 polishing machine, the films comprising either low-pressure CVD silica (SiO₂) or low-pressure CVD silicon nitride (Si₃N₄). The results are given in Table 1. The polishing rate is calculated by dividing the difference in thickness before and after the polishing by the polishing duration, the film thickness being measured by Nanospec. The polishing selectivity is calculated by dividing the polishing rate of silica by the polishing rate of silicon nitride. EXAMPLE 1

Levasil ® 50 CK/30% -V1, a colloidal silica sol precured from Bayer AG, Leverkusen, was diluted with deionized water, a polishing slurry containing 2% by weight of colloidal silica being obtained. The mean particle size of the colloidal silica is 60 to 90 nm, and the specific surface area is 50 to 180 m²/g. 4% by weight of ammonium hydrogen fluoride was added to the dilute polishing slurry and the mixture was thoroughly mixed. To adjust the pH to 3.8, an inorganic acid was added to the mixture, with the result that the desired polishing slurry was obtained. The results are given in Table 1.

### EXAMPLE 2

The same processes as in Example 1 were employed, except that the pH of the polishing slurry was set to 5. The results are given in Table 1

### EXAMPLE 3

The same processes as in Example 1 were employed, except that ammonium hydrogen fluoride was added in a quantity of 1% by weight. Furthermore, the pH of the polishing slurry was set at 3.8. The results are given in Table 1.

### EXAMPLE 4

The same processes as in Example 1 were employed, except that ammonium hydrogen fluoride was added in a quantity of 1% by weight and the pH of the polishing slurry was set to 5. The results are given in Table 1.

### COMPARATIVE EXAMPLE 1

SS 25, a polishing slurry which was procured from Cabot Microelectronics, Aurora, Ill., USA and contains pyrogenic silica was diluted with deionized water, so that a polishing slurry containing 2% by weight of silica was obtained. The pH of the polishing slurry was 11.2. The results are given in Table 1.

It can be seen from the above examples that the polishing slurry of the colloidal silica type, as a result of a fluoride salt being added, has a much higher polishing selectivity in terms of the rate at which silica is removed compared to the rate at which silicon nitride is removed, than a conventional polishing slurry comprising pyrogenic silica.

The above description of the preferred embodiments of this invention has been given for reasons of explanation and description. Evident modifications or variations are possible in view of the above teaching. The embodiments have been selected and described in order to offer the best illustration of the principles of this invention and its practical application and, in this way, to enable the person skilled in the art to employ the invention in various embodiments and using various modifications which are appropriate to the specific use intended. All modifications and variations lie within the scope of the present invention.

TABLE 1

| | | | Ammonium | | | |
|---|---|---|---|---|---|---|
| | | Silica | hydrogen fluoride | | Polishing | |
| | | concentration | concentration | | rate, SiO₂ | Polishing |
| Examples | Silica source | (% by weight) | (% by weight) | pH | (Å/min) | selectivity |
| Example 1 | Colloidal silica | 2% | 4% | 3.8 | 2021 | 11.5 |
| Example 2 | Colloidal silica | 2% | 4% | 5 | 1785 | 11.8 |
| Example 3 | Colloidal silica | 2% | 1% | 3.8 | 438 | 1.0 |
| Example 4 | Colloidal silica | 2% | 1% | 5 | 1090 | 3.6 |
| Comp. Ex. 1 | Pyrogenic silica | 2% | 0 | 11.2 | 350 | 0.5 |

Although the present invention has been described in detail with reference to certain preferred versions thereof, other variations are possible. Therefore, the spirit and scope of the appended claims should not be limited to the description of the versions contained therein.

What is claimed is:

1. An acidic polishing slurry comprising:
(a) from about 0.1 to about 5%, by weight, of a colloidal silica abrasive, and
(b) from about 0.5 to about 10%, by weight, of a fluoride salt.

2. The polishing slurry according to claim 1, wherein the colloidal silica abrasive is present in a quantity ranging from about 0.1 to about 3.5% by weight and the fluoride salt is present in a quantity of from about 1 to about 6%, by weight.

3. The polishing slurry according to claim 1, wherein the fluoride salt is an ammonium salt.

4. The polishing slurry according to claim 3, wherein the fluoride salt is ammonium fluoride or ammonium hydrogen fluoride.

5. The polishing slurry according to claim 4, wherein the fluoride salt is ammonium hydrogen fluoride.

6. The polishing slurry according to claim 1, wherein it has a pH at 22° C. ranging from about 2 to about 6.

7. The polishing slurry according to claim 1, wherein the colloidal silica has a mean particle size of from about 10 nm to about 1 μm.

8. The polishing slurry according to claim 7, wherein the colloidal silica has a mean particle size of from about 20 nm to about 100 nm.

9. A method comprising polishing a composite material containing silica and silicon nitride with an acidic polishing slurry comprising:
(a) from about 0.1 to about 5%, by weight, of a colloidal silica abrasive, and
(b) from about 0.5 to about 10%, by weight, of a fluoride salt.
